(19) United States
(12) Patent Application Publication
(10) Pub. No.: US 2020/0019690 A1
(43) Pub. Date: Jan. 16, 2020

(54) BIOMETRIC AUTHENTICATION SYSTEM AND BIOMETRIC AUTHENTICATION METHOD USING FREQUENCY RESPONSE CHARACTERISTICS OF BIOMETRIC SIGNAL

(71) Applicant: ELECTRONICS AND TELECOMMUNICATIONS RESEARCH INSTITUTE, Daejeon (KR)

(72) Inventors: Joo Yong SIM, Daejeon (KR); Hyung Wook NOH, Sejong (KR); Chang-Geun AHN, Sejong (KR)

(21) Appl. No.: 16/510,312

(22) Filed: Jul. 12, 2019

(30) Foreign Application Priority Data
Jul. 12, 2018 (KR) 10-2018-0081322
Jun. 28, 2019 (KR) 10-2019-0077976

(51) Int. Cl. G06F 21/32

(52) U.S. Cl. CPC G06F 21/32

(57) ABSTRACT

Provided is a biometric authentication system for authenticating a user. The biometric authentication system includes an input function generator generating an input function for determining a first time interval in a transmission interval in which an input signal is transmitted to a user, a second time interval in the transmission interval, a first frequency of the first time interval, and a second frequency of the second time interval, an input signal generator transmitting the input signal having the first frequency during the first time interval and the second frequency during the second time interval, to the user, based on the input function, and an authenticator acquiring a biometric signal generated in response to the input signal from the user and determining whether the user is authenticated based on the biometric signal.

### CROSS-REFERENCE TO RELATED APPLICATIONS

This U.S. non-provisional patent application claims priority under 35 U.S.C. § 119 of Korean Patent Application No. 10-2018-0081322, filed on Jul. 12, 2018, and 10-2019-0077976, filed on Jun. 28, 2019, the entire contents of which are hereby incorporated by reference.

### BACKGROUND

Embodiments of the inventive concept relate to a biometric authentication system, and more particularly, to a biometric authentication system and a biometric authentication method using frequency response characteristics of a biometric signal.

Security technologies using biometric authentication are used as a means for verifying the identity of a person, by extracting, storing, and determining person's physical characteristics, for example, fingerprints, a face, irises, or the like, by using the automated information technology. In a hyper-connect era with the 4th Industrial Revolution, importance of and the demand on the security technology using the biometric authentication have been increasing.

However, commercial image-based biometric authentication technologies are vulnerable to duplication and theft. In addition, unlike a password-based authentication technology, since it may be impossible to change patterns in the case of the image-based biometric authentication technology, security risks, such as theft and duplication, are relatively high. Recently, to avoid difficulties of the image-based biometric authentication technology, a biometric authentication technology using frequency response characteristics is developed.

### SUMMARY

Embodiments of the inventive concept provide a biometric authentication system and a biometric authentication method, which use frequency response characteristics of a biometric signal.

According to an exemplary embodiment of the inventive concept, a biometric authentication system for authenticating a user may include an input function generator, an input signal generator, and an authenticator. The input function generator generates an input function for determining a first time interval in a transmission interval in which an input signal is transmitted to the user, a second time interval in the transmission interval, a first frequency of the first time interval, and a second frequency of the second time interval. The input signal generator transmits the input signal having the first frequency during the first time interval and the second frequency during the second time interval, to the user, based on the input function. The authenticator acquires a biometric signal generated in response to the input signal from the user and determines whether the user is authenticated based on the biometric signal.

According to another exemplary embodiment of the inventive concept, a biometric authentication system for authenticating a user may include an input function generator, an input signal generator, and an authenticator. The input function generator generates an input function for determining a first time interval in a transmission interval in which an input signal is transmitted to the user, a second time interval in the transmission interval, a first frequency and a second frequency of the first time interval, and a third frequency and a fourth frequency of the second time interval. The input signal generator generates the input signal by synthesizing the first and second frequencies during the first time interval and by synthesizing the third and fourth frequencies during the second time interval, based on the input function, and transmits the input signal to the user. The authenticator acquires a biometric signal generated in response to the input signal from the user and determines whether the user is authenticated based on the biometric signal.

According to another exemplary embodiment of the inventive concept, a biometric authentication method may include generating an input function for determining a first time interval in a transmission interval in which an input signal is transmitted to a user, a second time interval in the transmission interval, a first frequency of the first time interval, and a second frequency of the second time interval, transmitting the input signal having the first frequency during the first time interval and the second frequency during the second time interval, to the user, based on the input function, and acquiring a biometric signal generated in response to the input signal, from the user, extracting a template from the biometric signal, and determining whether the user is authenticated, based on the template.

### BRIEF DESCRIPTION OF THE FIGURES

The above and other objects and features of the inventive concept will become apparent by describing in detail exemplary embodiments thereof with reference to the accompanying drawings.

FIG. 1 is a block diagram illustrating a biometric authentication system according to an embodiment of the inventive concept.

FIG. 2 is a block diagram illustrating an input function generator of FIG. 1.

FIG. 3 is a block diagram illustrating an authenticator of FIG. 1.

FIG. 4 is a graph illustrating magnitudes of a biometric signal versus frequencies of an input signal provided to a user according to an embodiment of the inventive concept.

FIG. 5 is a graph illustrating an input function according to an embodiment of the inventive concept.

FIG. 6 is a graph illustrating a biometric signal generated from a user in response to an input signal which is generated depending on an input function of FIG. 5.

FIGS. 7 to 11 are graphs illustrating first to fifth input functions according to some embodiments of the inventive concept.

FIG. 12 is a flowchart illustrating a biometric authentication method according to an embodiment of the inventive concept.

FIG. 13 is a flowchart illustrating operation S140 of FIG. 12 in detail.

FIG. 14 is a flowchart illustrating operation S170 of FIG. 12 in detail.

### DETAILED DESCRIPTION

Embodiments of the inventive concept will be described below in more detail so that those skilled in the art can easily carry out the inventive concept.

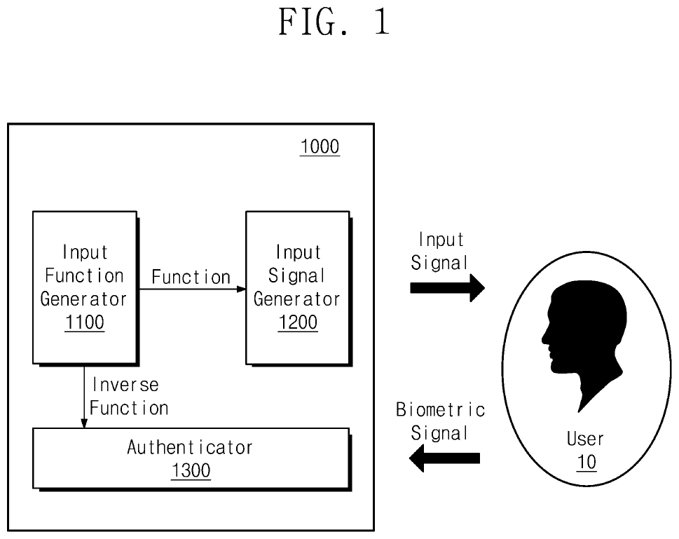

FIG. 1 is a block diagram illustrating a biometric authentication system according to an embodiment of the inventive concept. A biometric authentication system 1000 may transmit an input signal to a user 10, may obtain a biometric signal from the user 10, and may authenticate the user 10, based on the biometric signal. In detail, the biometric authentication system 1000 may transmit the input signal, of which a frequency varies with a time, to the user 10 and may operate based on the input signal and frequency response characteristics of the biometric signal. Since the biometric signal has a number of various transmission characteristics depending on complex human body structures of the user 10, the biometric signal may be sufficiently used as authentication means, and it may be considered that duplication is almost impossible in comparison with the image-based technology. The biometric authentication system 1000 may use the biometric signal obtained from at least one of the various body parts of the user 10 including an iris, a fingerprint, and a face, to authenticate the user 10.

The biometric authentication system 1000 may include an input function generator 1100, an input signal generator 1200, and an authenticator 1300. The biometric authentication system 1000 may be implemented with a single device including the input function generator 1100, the input signal generator 1200, and the authenticator 1300, or may be implemented by using separate devices respectively corresponding to the input function generator 1100, the input signal generator 1200, and the authenticator 1300.

The biometric authentication system 1000 may be implemented to contact the user 10, or may be implemented to be spaced apart from the user 10. In the former case, the biometric authentication system 1000 may transmit the input signal to the user 10 via an electrode. In the latter case, the biometric authentication system 1000 may transmit the input signal to the user 10 by using wireless communication devices such as an electromagnetic wave generator, and a sound generator.

The input function generator 1100 may generate an input function for generating an input signal. In detail, the input function includes frequency information of the input signal over time. The input function may include information on the frequency of the input signal that varies during a transmission interval in which the input signal is transmitted to the user 10.

The input function generator 1100 may generate the input function, which independently determines a plurality of time intervals in the transmission interval in which the input signal is transmitted to the user 10, and frequencies of the plurality of time intervals. For example, the input function generator 1100 may generate the input function by randomizing the frequencies and the plurality of time intervals. In this case, the input function generator 1100 may use a random function.

The random function may be used as a means for randomly mapping certain time intervals and certain frequencies in the transmission interval. The function generation process in which the input function generator 1100 generates a function may be referred to as a “biometric scanning protocol encryption process” based on the function including a random frequency and a random duration. A technology for preventing hacking of the biometric authentication system 1000 may be implemented through the biometric scanning protocol encryption process.

The input function generator 1100 may generate the input function that determines one frequency at a point in the transmission interval and may also generate the input function that determines two or more frequencies at a time point in the transmission interval. In detail, the input function generator 1100 may generate the input function that individually determines at least one frequency and at least one duration with regard to each of the plurality of time intervals in the transmission interval.

The input function generator 1100 may generate an inverse function of the generated input function. In this description, the inverse function of the input function may be used as a means for recovering the biometric signal in response to the input signal, based on the input function. The input function generator 1100 may provide the inverse function of the generated input function to the authenticator 1300.

The input signal generator 1200 may generate an input signal based on the input function which is generated by the input function generator 1100. For example, the frequency of the input signal generated by the input signal generator 1200 may be a frequency determined depending on the input function. The input signal generator 1200 may transmit the input signal to the user 10. The input signal generator 1200 may transmit the input signal toward at least one of various body parts of the user 10 including eyes, hands, or a face. The input signal generator 1200 may generate the input signal having various waveforms, magnitudes, and frequencies. The input signal generator 1200 may generate the input signal as at least one of optical, acoustic, and electrical signals.

The input signal generator 1200 may generate sound, electricity, and electromagnetic waves as the input signal. The input signal generator 1200 may modulate the frequency, wavelength, period, magnitude, and phase of the sound, electricity, and electromagnetic waves to generate the input signal. The input signal generator 1200 may be implemented by various hardware devices that generate the sound, the electricity, and the electromagnetic waves and modulate the frequency, the wavelength, the period, the magnitude, and the phase thereof.

The authenticator 1300 may acquire the biometric signal, which is generated in response to the input signal, from the user 10. The authenticator 1300 may extract a template from the biometric signal. The template may refer to data representing a unique characteristic of the user 10 included in the acquired biometric signal. Alternatively, the authenticator 1300 may receive the inverse function of the input function from the input function generator 1100, may recover the biometric signal by using the inverse function of the input function, and may extract the template from the recovered biometric signal. The authenticator 1300 may store the template and may calculate an authentication score for authenticating the user 10 based on the template. The authenticator 1300 may determine whether the user 10 has been authenticated based on the authentication score.

The input function generator 1100 and the authenticator 1300 may be implemented with a hardware including a processor (e.g., a central processing unit (CPU), a graphics processing unit (GPU), a neural processing unit (NPU), a digital signal processor (DSP), etc.), and dedicated circuits (e.g., field programmable gate arrays (FPGAs), application specific integrated circuits (ASICs), etc.), or may be implemented as a system on chip (SoC).

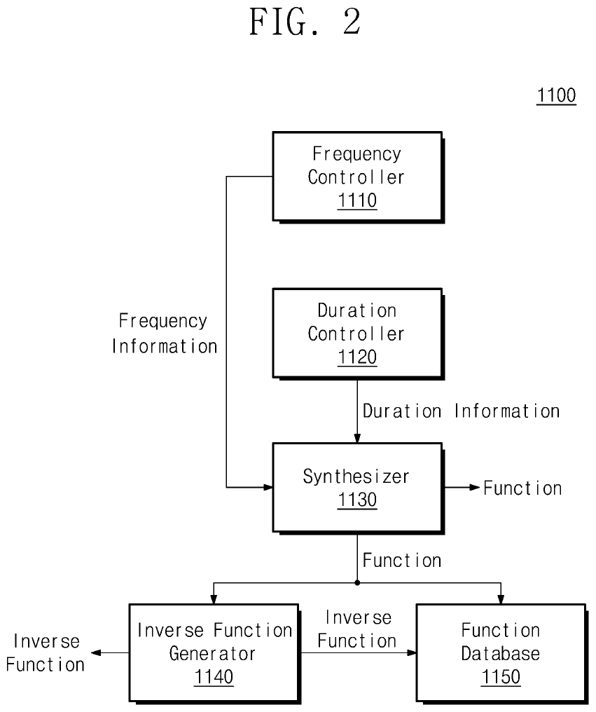

FIG. 2 is a block diagram illustrating an input function generator of FIG. 1. An input function generator 1100 of FIG. 2 will be described with reference to FIG. 1. The input function generator 1100 may include a frequency controller 1110, a duration controller 1120, a synthesizer 1130, an inverse function generator 1140, and a function database 1150.

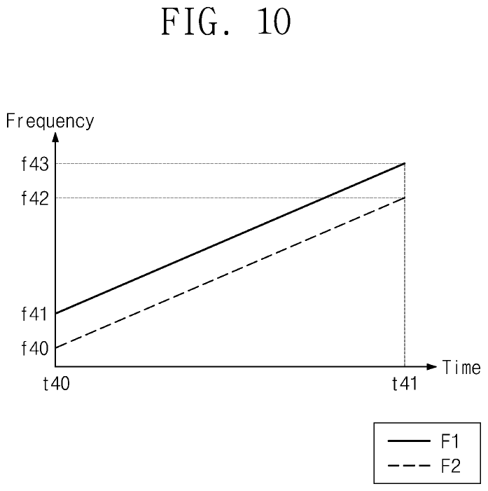

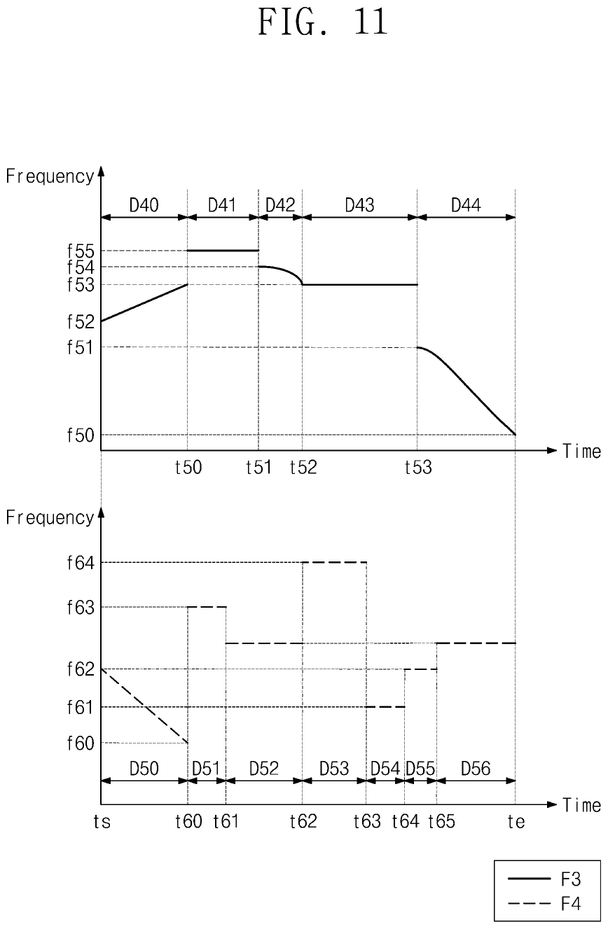

The frequency controller 1110 may randomly determine or control at least one frequency for each of a plurality of time intervals in the transmission interval in which the input signal is transmitted to user 10. The frequency controller 1110 may generate frequency information including the determined frequencies. The frequency controller 1110 may generate the input function by determining one frequency for one time point in the transmission interval and may also determine two or more frequencies (e.g., graphs of FIGS. 10 and 11 to be described below) for a time point.

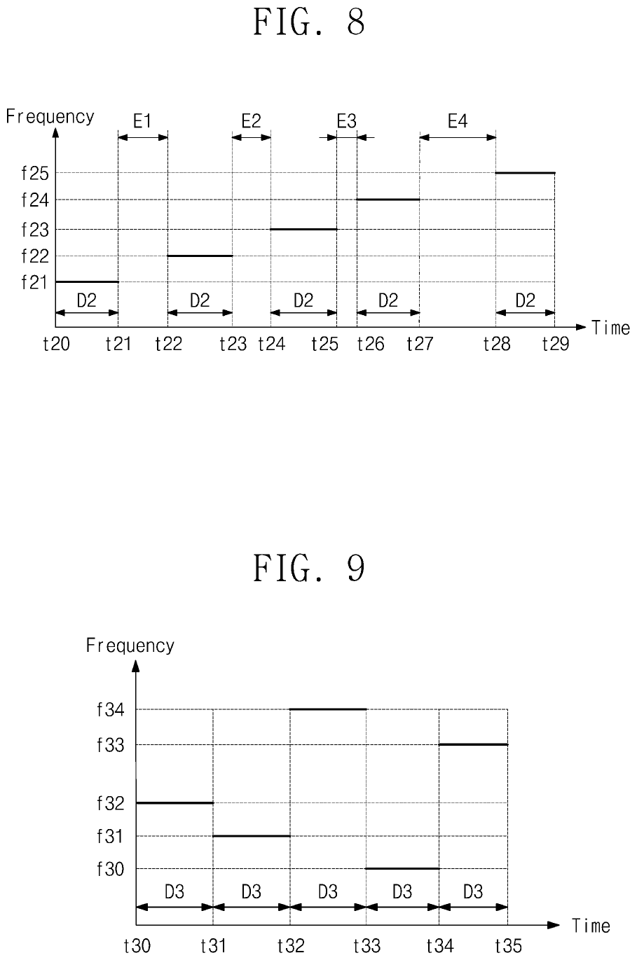

As an example, the frequency controller 1110 may determine that the frequency at a first time interval among the plurality of time intervals in the transmission interval, has a first value. The frequency controller 1110 may determine that the frequency at a second time interval among a plurality of time intervals between a time point at which an output of the input signal starts and a time point time at which the output of the input signal ends, has a second value. In this case, the first value may be different from the second value. The frequency controller 1110 may determine that frequencies for the plurality of time intervals in a function have different uniform values, and that the uniform values of the frequencies increase or decrease over time (e.g., a graph of FIG. 8). Alternatively, the frequency controller 1110 may randomly determine uniform values of the frequencies for the plurality of time intervals (e.g., a graph of FIG. 9).

As another example, the frequency controller 1110 may determine that the frequency at the first time interval among the plurality of time intervals in the transmission interval increases or decreases linearly (or non-linearly) over time, and frequencies in the entirety of the plurality of time intervals may be irregular (may not increase or decrease linearly, or non-linearly) (e.g., a graph of FIG. 5).

The duration controller 1120 may randomly determine or control at least one duration for each of the plurality of time intervals in the transmission interval during which the input signal is transmitted to the user 10. The duration controller 1120 may generate duration information that includes the determined durations. The duration controller 1120 may randomly determine durations of the respective time intervals. For example, the duration controller 1120 may determine a first duration from a first time point to a second time point, and a second duration from a third time point to a fourth time point (the second time point may be the same as or different from the third time point). The duration controller 1120 may determine the first duration and the second duration to be different from each other.

The synthesizer 1130 may receive frequency information from the frequency controller 1110, and may receive duration information from the duration controller 1120. The synthesizer 1130 may generate the input function based on frequencies and durations determined by the frequency controller 1110 and the duration controller 1120. When the frequency controller 1110 determines two or more frequencies for one time point between a time point at which the output of the input signal starts and a time point at which the output of the input signal ends, the synthesizer 1130 may generate the input function by synthesizing the two or more frequencies at the one time point. The synthesizer 1130 may provide the input function to the input signal generator 1200.

The inverse function generator 1140 may receive the input function generated from the synthesizer 1130. The inverse function generator 1140 may generate an inverse function of the input function. The inverse function may be used for the authenticator 1300 to recover the biometric signal which is generated in response to the input signal.

The function database 1150 may store the input functions generated by the synthesizer 1130 and the inverse functions generated by the inverse function generator 1140. The input function generator 1100 may load a function from the function database 1150, and may provide the loaded function to the input signal generator 1200.

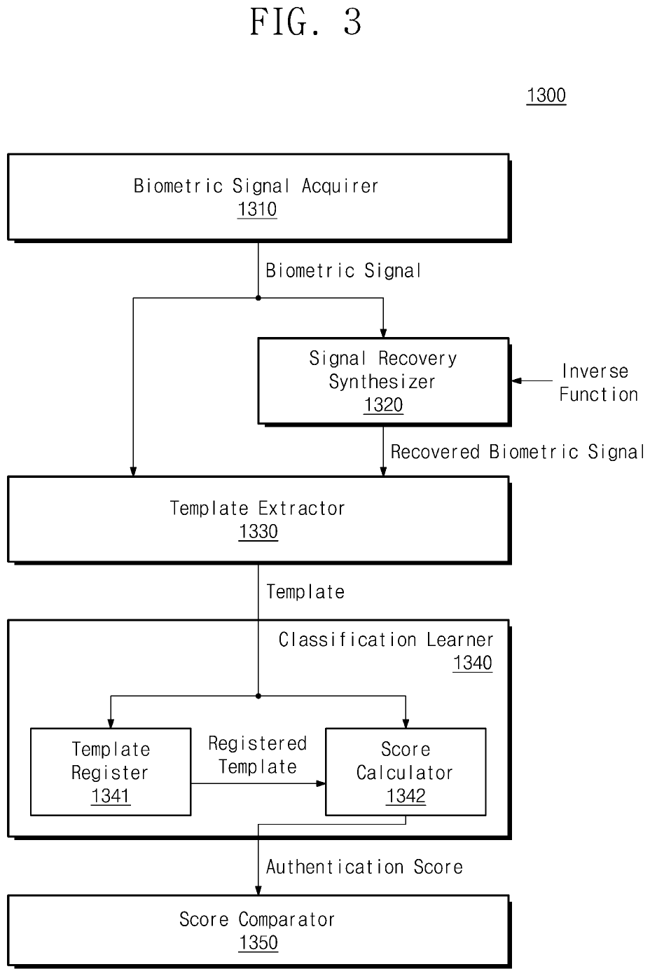

FIG. 3 is a block diagram illustrating an authenticator of FIG. 1. FIG. 3 will be described with reference to FIG. 1. The authenticator 1300 may include a biometric signal acquiring unit 1310, a signal recovery synthesizer 1320, a template extractor 1330, a classification learning unit 1340, and a score comparator 1350.

The biometric signal acquiring unit 1310 may acquire a biometric signal generated from the user 10 in response to the input signal. The biometric signal acquiring unit 1310 may acquire the biometric signal by using at least one of optical, acoustic, and electrical units. In detail, the biometric signal acquiring unit 1310 may be implemented by various sensors such as an optical sensor, an acoustic sensor, and an electrical sensor, or by a combination thereof.

The signal recovery synthesizer 1320 may recover the biometric signal which is collected by the biometric signal acquiring unit 1310. In this case, the signal recovery synthesizer 1320 may receive the inverse function of the input function from the input function generator 1100, and may use the inverse function to recover the biometric signal. Since authentication for the user 10 is not always accomplished based on the recovered biometric signal, the signal recovery synthesizer 1320 may selectively recover the biometric signal.

The template extractor 1330 may extract a template from the biometric signal or the recovered biometric signal. In some cases, the template extractor 1330 may select the biometric signal or the recovered biometric signal to extract the template. The template may reflect characteristics of various body parts (e.g., an iris, a fingerprint, a face, etc.) of the user 10.

The classification learning unit 1340 may calculate the authentication score of the user 10, based on the template. The classification learning unit 1340 may include a template register 1341 and a score calculator 1342. The template register 1341 may register and store the template. However, when the user 10 is already registered, the template register 1341 may skip the template registration process. In detail, to determine whether the user 10 is registered, the template register 1341 may check whether another template associated with the user 10 is already stored. When the user 10 is not registered, the template register 1341 may register and store the template. The template which is registered and stored in the template register 1341 may be referred to as a “registered template”.

The score calculator 1342 may generate a learning model, based on the registered templates which are stored in the template register 1341. In this case, the learning model may be a model learned to classify the template of the user 10 depending on a similarity with the registered templates. The score calculator 1342 may apply the learning model to the template of the user 10, and the score calculator 1342 may calculate the authentication score of the user 10, based on a result of the application.

The score comparator 1350 may compare the authentication score of the user 10 with a reference score, and may determine whether the user 10 is authenticated, based on a result of the comparison. In this case, the reference score may be a predetermined value. When the authentication score of the user 10 is equal to or greater than the reference score, the score comparator 1350 may determine that the user 10 has succeeded in authenticating. When the authentication score of the user 10 is less than the reference score, the score comparator 1350 may determine that the authentication of the user 10 fails. The process in which user 10 is authenticated, by using the authentication score is not limited to the above description, and may be implemented by various numerical methods that may be applied by those of one skilled in the art.

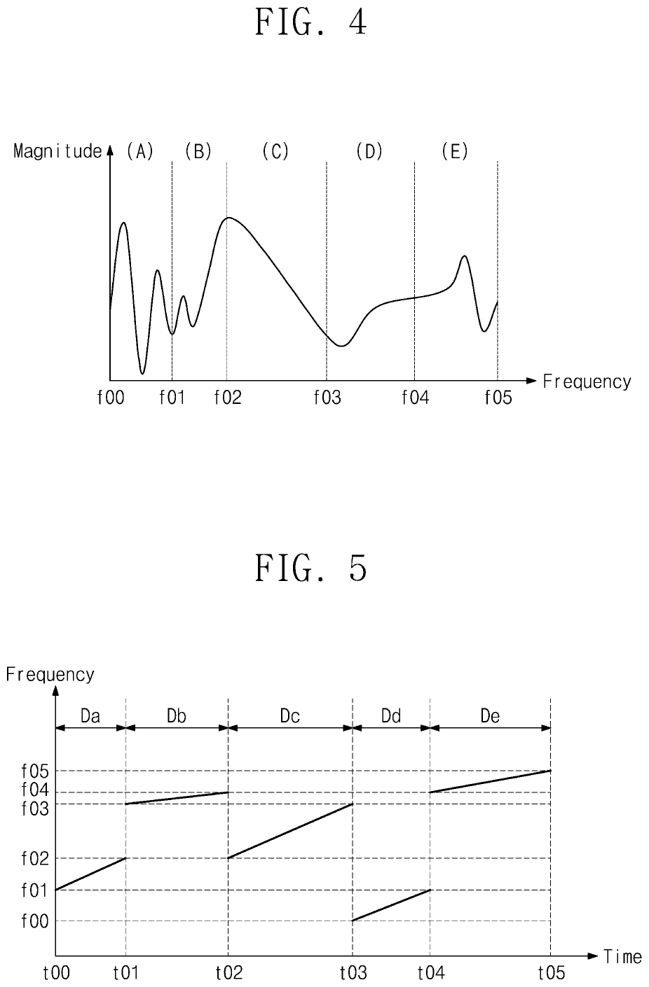

FIG. 4 is a graph illustrating magnitudes of a biometric signal versus frequencies of an input signal provided to a user according to an embodiment of the inventive concept. The frequency response characteristics of the biometric signal will be described with reference to FIG. 4. FIG. 4 will be described with reference to FIG. 1.

In FIG. 4, a horizontal axis indicates a frequency of the input signal which is provided to the user 10. A vertical axis indicates a magnitude of the biometric signal which is obtained from the user 10. The graph of FIG. 4 may be divided into regions (A), (B), (C), (D), and (E), depending on frequency intervals (f00 to f01, f01 to f02, f02 to f03, f03 to f04, and f04 to f05). In the regions (A), (B), (C), (D), and (E), the magnitude waveform of the biometric signal may have a unique characteristic in, each of the frequency intervals. Such characteristics may be referred to as “frequency response characteristics” of a biometric signal. The inventive concept will be implemented based on the frequency response characteristics of the biometric signal.

FIG. 5 is a graph illustrating an input function according to an embodiment of the inventive concept. FIG. 5 will be described with reference to FIGS. 1 and 2.

The input function generator 1100 may generate the function such that frequencies linearly increases in the first to fifth time intervals t00 to t01, t01 to t02, t02 to t03, t03 to t04, and t04 to t05, as illustrated in the graph of FIG. 5. The frequency associated with the first time interval t00 to t01 of the function may linearly increase from f01 to f02. The second to fifth time intervals t01 to t02, t02 to t03, t03 to t04, and t04 to t05 of the function may be similar to the first time interval t00 to t01 (a linear increase from f03 to f04, from f02 to f03, from f00 to f01, and from f04 to f05). However, since the input function generator 1100 may randomly determine the frequencies of the function, the frequencies may be irregular in the entire time interval t00 to t05 of the function. Also, since the input function generator 1100 may randomly determine durations Da, Db, Dc, Dd, and De of the first to fifth time intervals t00 to t01, t01 to t02, t02 to t03, t03 to t04, and t04 to t05, the durations Da, Db, Dc, Dd, and De may not be equal to one another.

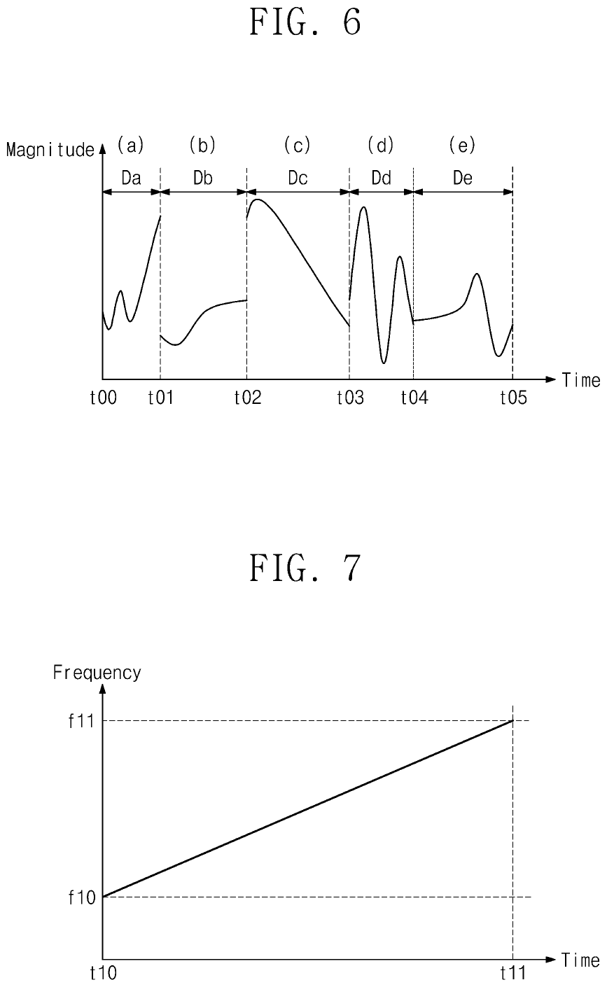

FIG. 6 is a graph illustrating a biometric signal generated from a user in response to an input signal which is generated depending on the input function of FIG. 5. FIG. 6 will be described with reference to FIGS. 1, 2 and 5.

In an embodiment, when the input signal generator 1200 provides the user 10 with the input signal which is generated based on the input function of FIG. 5, the authenticator 1300 may acquire the biometric signal which has the waveform of FIG. 6, from the user 10. The regions (a), (b), (c), (d), and (e) of the biometric signal may correspond to first through fifth time intervals t00 to t01, t01 to t02, t02 to t03, t03 to t04, and t04 to t05 of the input function in FIG. 5, respectively. Since the frequencies and the durations of the input signal which is generated based on the input function of FIG. 5 are randomly determined, the waveform of FIG. 6 may be different from the waveform of FIG. 4. The regions (a), (b), (c), (d) and (e) of the biometric signal of FIG. 6 may correspond to the regions (B), (D), (C), (A), and (E) of FIG. 4, respectively. In detail, the biometric signal that is generated based on the input signal having the frequencies which are randomly determined, may have random patterns.

When the signal recovery synthesizer 1320 recovers the biometric signal of FIG. 6 by using the inverse function of the input function of FIG. 5, the recovered biometric signal may have the waveform illustrated in FIG. 4. In detail, the biometric authentication system 1000 may determine whether the user 10 is authenticated, based on the biometric signal which is recovered by using the inverse function by the signal recovery synthesizer 1320. Alternatively, the biometric authentication system 1000 may determine whether the user 10 is authenticated, based on the biometric signal that is generated based on the input signal randomized by the input function.

FIGS. 7 to 11 are graphs illustrating first to fifth input functions according to some embodiments of the inventive concept. FIGS. 7 to 11 will be described with reference to FIGS. 1 and 2.

As an embodiment in FIG. 7, the input function generator 1100 may determine a first input function, defining that the frequency linearly increases from f10 to f11 in a time interval t10 to t11. The input signal generator 1200 may generate the input signal of which the frequency linearly increases from f10 to f11 in the time interval t10 to t11 based on the first input function. In contrast to FIG. 7, the input function generator 1100 may determine another input function, defining that the frequency linearly decreases from f11 to f10 in the time interval t10 to t11, and the input signal generator 1200 may also generate the input signal of which the frequency linearly decreases from f11 to f10 in the time interval t10 to t11 based on the other input function.

As another embodiment in FIG. 8, the input function generator 1100 may determine a second input function. The second input function is a function, defining that each of durations of time intervals t20 to t21, t22 to t23, t24 to t25, t26 to t27, and t28 to t29 is D2, frequencies of the time intervals t20 to t21, t22 to t23, t24 to t25, t26 to t27, and t28 to t29 are f21, f22, f23, f24 and f25, respectively, durations of the time intervals t21 to t22, t23 to t24, t25 to t26, and t27 to t28 are E1, E2, E3 and E4, respectively, and the input signal is not provided to the user 10 in the time intervals t21 to t22, t23 to t24, t25 to t26, and t27 to t28. Referring to FIG. 8, the frequencies f21, f22, f23, f24, and f25 are gradually-increasing values. Referring to the durations E1, E2, E3, and E4, the input signal generator 1200 provides the user 10 with the input signal intermittently. Unlike durations illustrated in FIG. 8, the durations of the time intervals t20 to t21, t22 to t23, t24 to t25, t26 to t27, and t28 to t29 may not be the same as one another, the durations of the time intervals t21 to t22, t23 to t24, t25 to t26, and t27 to t28 may be the same as one another, and the frequencies f21, f22, f23, f24, and f25 may gradually decrease.

As another embodiment in FIG. 9, the input function generator 1100 may generate a third input function. The third input function is a function, defining that each of the durations of time intervals t30 to t31, t31 to t32, t32 to t33, t33 to t34, and t34 to t35 is D3, and the frequencies of the time intervals t30 to t31, t31 to t32, t32 to t33, t33 to t34, and t34 to t35 are f32, f31, f34, f30, and f33, respectively. The input signal generator 1200 generates an input signal, of which a frequency varies irregularly for each of the time intervals t30 to t31, t31 to t32, t32 to t33, t33 to t34, and t34 to t35 which has a uniform duration, based on the third input function. Unlike durations illustrated in FIG. 9, the durations of the time intervals t30 to t31, t31 to t32, t32 to t33, t33 to t34, and t34 to t35 may be different from one another and may not be uniform.

As another embodiment in FIG. 10, the input function generator 1100 may generate a fourth input function that determines a first frequency F1 and a second frequency F2 with regard to a time interval t40 to t41. The input signal generator 1200 may generate the input signal by synthesizing the first frequency F1 and the second frequency F2. The first frequency F1 linearly increases from f41 to f43 in the time interval t40 to t41 and the second frequency F2 linearly increases from f40 to f42 in the time interval t40 to t41. The synthesizer 1130 may generate a fourth input function that determines the first frequency F1 and the second frequency F2. The input signal generator 1200 may generate the input signal by synthesizing the first frequency F1 and the second frequency F2, based on the fourth input function.

As another embodiment in FIG. 11, the input function generator 1100 may generate a fifth input function that determines a third frequency F3 and a fourth frequency F4. The input signal generator 1200 may generate the input signal by synthesizing the third frequency F3 and the fourth frequency F4. The input function generator 1100 may determine that the durations of the time intervals ts to t50, t50 to t51, t51 to t52, t52 to t53 and t53 to te of the third frequency F3 are D40, D41, D42, D43 and D44, respectively. The input function generator 1100 may randomly determine frequencies with regard to the time intervals ts to t50, t50 to t51, t51 to t52, t52 to t53, and t53 to te of the third frequency F3, in between f50 to f55. The input function generator 1100 may determine that time durations of the time intervals ts to t60, t60 to t61, t61 to t62, t62 to t63, t63 to t64, t64 to t65, and t65 to te of the fourth frequency F4 are D50, D51, D52, D53, D54, D55, and D56, respectively. The input function generator 1100 may randomly determine frequencies with regard to the time intervals ts to t60, t60 to t61, t61 to t62, t62 to t63, t63 to t64, t64 to t65, t65 to te of the fourth frequency F4 in between f60 to f64. The input function generator 1100 may generate the fifth input function that determines the third frequency F3 and the fourth frequency F4 in the time interval ts to te. The input signal generator 1200 may generate the input signal by synthesizing the third frequency F3 and the fourth frequency F4, based on the fifth input function.

The biometric authentication system 1000 according to an embodiment of the inventive concept may also be provided by combining examples of generating the input signals described in FIGS. 7 to 11. In addition, the inventive concept is not limited to these embodiments, and may be easily modified by one skilled in the art.

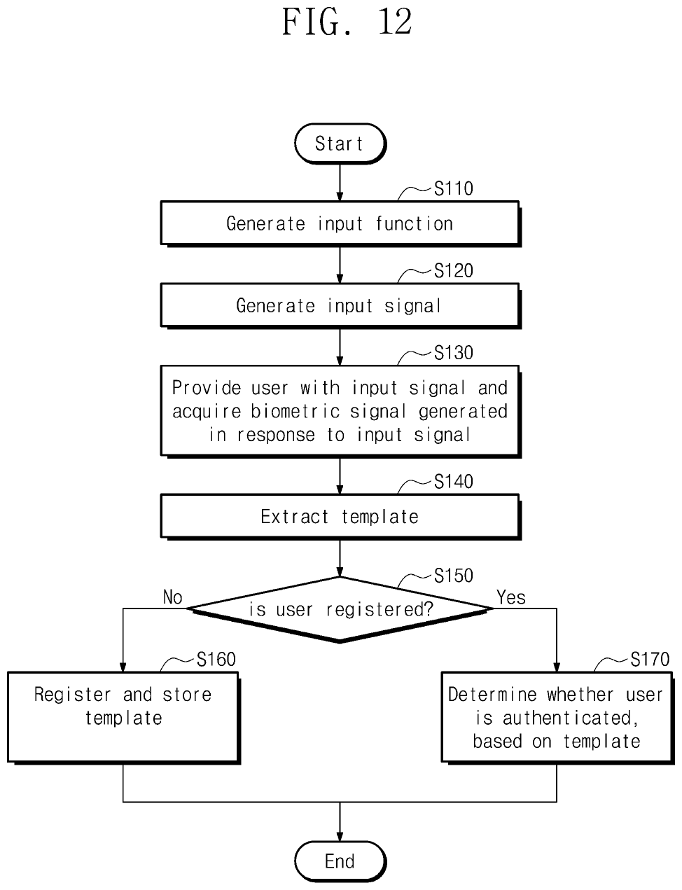

FIG. 12 is a flowchart illustrating a biometric authentication method according to an embodiment of the inventive concept. FIG. 12 will be described with reference to FIGS. 1 to 3.

In operation S110, the input function generator 1100 may generate the input function that independently defines frequencies and durations with regard to a plurality of time intervals between a time point at which the output of the input signal starts and a time point at which the output of the input signal ends. The input function generator 1100 may independently determine the frequencies and the durations with regard to the plurality of time intervals between the time point at which the output of the input signal starts and the time point at which the output of the input signal ends, and may generate the input function including frequencies and durations associated with the respective time intervals. The input function generator 1100 may generate the input function by determining one frequency at a time point between a time point at which the output of the input signal starts and a time point at which the output of the input signal ends, or may generate the input function by synthesizing two or more frequencies for a time point.

In operation S120, the input signal generator 1200 may generate the input signal. The input signal generator 1200 may generate the input signal, based on the input function generated by the input function generator 1100. The frequency of the input signal generated by the input signal generator 1200 may vary depending on the input function generated by the input function generator 1100.

In operation S130, the input signal generator 1200 may provide the input signal to the user 10. The biometric signal acquiring unit 1310 may acquire the biometric signal which is generated in response to the input signal, from the user 10.

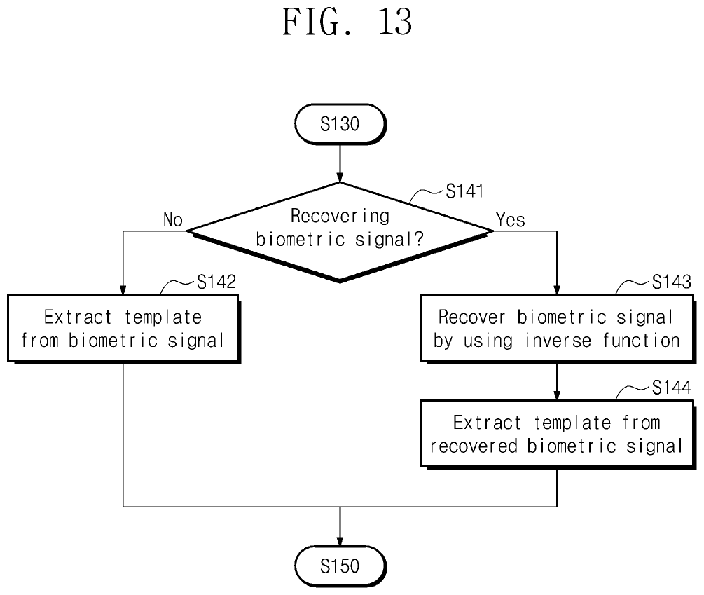

In operation S140, the template extractor 1330 may extract the template of the user 10. In some cases, to extract the template, the template extractor 1330 may select the biometric signal or the recovered biometric signal. The operation S140 will be described in more detail with reference to FIG. 13.

In operation S150, the classification learning unit 1340 may determine whether the user 10 is registered. When it is determined that the user 10 is not registered, operation S160 may be performed. When it is determined that the user 10 is registered, operation S170 may be performed. Whether or not the user 10 is registered may be determined depending on whether or not the template of the user 10 is previously stored in the template register 1341. In the case where the template of the user 10 is stored in the template register 1341, the classification learning unit 1340 may determine that the user 10 is registered. In the case where the template of the user 10 is not stored in the template register 1341, the classification learning unit 1340 may determine that the user 10 is not registered.

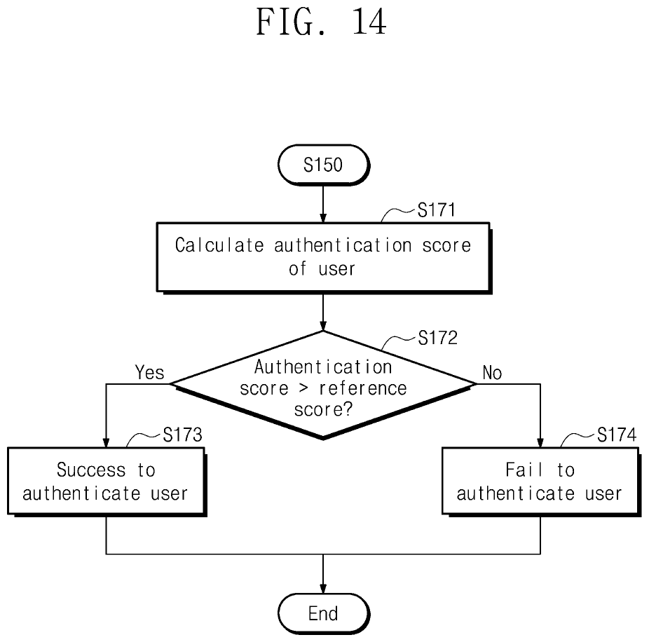

In operation S160, the template register 1341 may register and store the template of the user 10. In operation S170, the classification learning unit 1340 may determine whether the user 10 is authenticated, based on the template. The operation S170 will be described in more detail with reference to FIG. 14.

FIG. 13 is a flowchart illustrating operation S140 of FIG. 12 in detail. FIG. 13 will be described with reference to FIGS. 3 and 12.

In operation S141, the authenticator 1300 may determine whether to extract the template from the recovered biometric signal. When it is determined that the template is extracted from the recovered biometric signal, operation S143 may be performed. Otherwise, operation S142 may be performed.

In operation S142, the template extractor 1330 may extract the template from the biometric signal which is acquired by the biometric signal acquiring unit 1310. In operation S143, the inverse function generator 1140 may generate the inverse function of the input function. The signal recovery synthesizer 1320 may receive the inverse function from the inverse function generator 1140, and may recover and synthesize the biometric signal by using the inverse function. In operation S144, the template extractor 1330 may extract the template from the recovered biometric signal.

FIG. 14 is a flowchart illustrating operation S170 of FIG. 12 in detail. FIG. 13 will be described with reference to FIGS. 3 and 12.

In operation S171, the classification learning unit 1340 may calculate the authentication score of the user 10. To calculate the authentication score, the classification learning unit 1340 may generate the learning model, based on the registered templates which are stored in the template register 1341. The score calculator 1342 may apply the learning model to the template of the user 10, and may calculate the authentication score of the user 10, based on a result of the applying.

In operation S172, operation S173, and operation S174, the classification learning device 1340 may determine whether the user 10 is authenticated by comparing the authentication score of the user 10 with the reference score. In the operation S172, the classification learning unit 1340 may compare the authentication score of the user 10 with the reference score. When the authentication score of the user 10 is greater than the reference score, the operation S173 may be performed. Otherwise, the operation S174 may be performed. In the operation S173, the classification learning unit 1340 may determine that the user 10 is successfully authenticated. In the operation S174, the classification learning unit 1340 may determine that the authentication of the user 10 fails.

According to embodiments of the inventive concept, a biometric authentication system protects a template that is used in biometric authentication, by generating an input signal based on a random frequency synthesis and a random time function. Even though templates are leaked, the biometric authentication system prevents the leaked templates from being applied to authentication at all.

According to embodiments of the inventive concept, the biometric authentication system may solve the problem that templates such as templates of fingerprints or irises cannot be used permanently once leaked, and may solve the problem of encrypting the templates to protect the templates in the fingerprints and the irises recognition.

The contents described above are specific embodiments for implementing the inventive concept. The inventive concept may include not only the embodiments described above but also embodiments in which a design is simply or easily capable of being changed. In addition, the inventive concept may also include technologies easily changed to be implemented using embodiments. While the inventive concept has been described with reference to exemplary embodiments thereof, it will be apparent to those of ordinary skill in the art that various changes and modifications may be made thereto without departing from the spirit and scope of the inventive concept. Therefore, the scope of the inventive concept is not limited to the described embodiments but is defined by the claims and their equivalents.

What is claimed is:

1. A biometric authentication system comprising:
an input function generator configured to generate an input function determining a first time interval in a transmission interval in which an input signal is transmitted to a user, a second time interval in the transmission interval, a first frequency of the first time interval, and a second frequency of the second time interval;
an input signal generator configured to transmit the input signal having the first frequency during the first time interval and the second frequency during the second time interval, to the user, based on the input function; and
an authenticator configured to acquire a biometric signal generated in response to the input signal, from the user and to determine whether the user is authenticated, based on the biometric signal.

2. The biometric authentication system of claim 1, wherein the input signal generator does not transmit the input signal to the user during a third time interval in the transmission interval.

3. The biometric authentication system of claim 2, wherein the third time interval is between the first time interval and the second time interval.

4. The biometric authentication system of claim 1, wherein the input function generator further determines the first frequency at a start time point in the first time interval and a third frequency at an end time point in the first time interval, and
wherein the input signal generator transmits the input signal, which has the first frequency at the start time point and the third frequency at the end time point, to the user.

5. The biometric authentication system of claim 1, wherein
the input function generator comprises an inverse function generator configured to generate an inverse function of the input function,
wherein the authenticator comprises:
a signal recovery synthesizer configured to recover the biometric signal by using the inverse function; and
a template extractor configured to extract a template from the recovered biometric signal, and
wherein the authenticator determines whether the user is authenticated, based on the template.

6. The biometric authentication system of claim 5, wherein the input function generator further comprises a function database configured to store the input function and the inverse function.

7. The biometric authentication system of claim 1, wherein the authenticator comprises a template extractor configured to extract a template from the biometric signal, and
wherein the authenticator determines whether the user is authenticated, based on the template.

8. The biometric authentication system of claim 3, wherein the authenticator comprises a template register configured to store and register the template.

9. The biometric authentication system of claim 1, wherein the authenticator comprises a biometric signal acquiring unit configured to acquire the biometric signal from at least one of a fingerprint, a face, and an iris of the user.

10. A biometric authentication system comprising:
an input function generator configured to generate an input function determining a first time interval in a transmission interval in which an input signal is transmitted to a user, a second time interval in the transmission interval, a first frequency and a second frequency of the first time interval, and a third frequency and a fourth frequency of the second time interval
an input signal generator configured to generate the input signal by synthesizing the first and second frequencies during the first time interval and by synthesizing the third and fourth frequencies during the second time interval, based on the input function, and to transmit the input signal to the user; and
an authenticator configured to acquire a biometric signal generated in response to the input signal from the user and to determine whether the user is authenticated, based on the biometric signal.

11. The biometric authentication system of claim 10, wherein the input signal generator does not transmit the input signal to the user during a third time interval in the transmission interval.

12. The biometric authentication system of claim 11, wherein the third time interval is between the first time interval and the second time interval.

13. The biometric authentication system of claim 12, wherein the first time interval, the second time interval, and the third time interval are different from one another.

14. A biometric authentication method comprising:
generating an input function for determining a first time interval in a transmission interval in which an input signal is transmitted to a user, a second time interval in the transmission interval, a first frequency at the first time interval, and a second frequency at the second time interval;
transmitting the input signal having the first frequency during the first time interval and the second frequency during the second time interval, to the user, based on the input function, and acquiring a biometric signal generated in response to the input signal from the user;
extracting a template from the biometric signal; and
determining whether the user is authenticated, based on the template.

15. The biometric authentication method of claim 14, further comprising:
determining whether the user is registered; and
when the user is not registered, storing and registering the template of the user.

16. The biometric authentication method of claim 14, wherein the determining whether the user is authenticated, based on the template, comprises:
calculating an authentication score of the user; and
determining that the user is succeeded in authenticating when the authentication score is greater than or equal a reference score, and determining that the user is failed to authenticate when the authentication score is less than the reference score.

17. The biometric authentication method of claim 16, wherein the calculating the authentication score of the user comprises:
applying a learning model to the template of the user and calculating the authentication score of the user based on a result of the applying.
